(19) United States
(12) Patent Application Publication
(10) Pub. No.: US 2010/0005419 A1
(43) Pub. Date: Jan. 7, 2010

(54) Information display apparatus

(75) Inventors: Tadahiro Miichi, Nishinomiya-city (JP); Brice Pryszo, Bidart (FR)

Correspondence Address: BIRCH STEWART KOLASCH & BIRCH, PO BOX 747, FALLS CHURCH, VA, 22040-0747, US

(73) Assignees: Furuno Electric Co., Ltd.; MaxSea International S.A.S.

(21) Appl. No.: 12/081,019

(22) Filed: Apr. 9, 2008

(30) Foreign Application Priority Data
Apr. 10, 2007 (JP) 2007-102484

(51) Int. Cl. G06F 3/048

(52) U.S. Cl. 715/828; 715/834

(57) ABSTRACT

An information display apparatus comprises a plurality of sensing devices, a signal processing block, an information display block, a menu storage block, a rotary control like a rotary encoder and a menu display block. The information display apparatus presents selectable menu items relating to images displayed on-screen together with information on hierarchical level of the menu items so that a user can easily recognize the hierarchical level of the currently presented menu items. The rotary control permits the user to select a desired one of the presented menu items by simple operation.

### CROSS REFERENCE OF RELATED APPLICATION

Japanese Patent Application tokugan No. 2007-102484 is hereby incorporated by reference.

### BACKGROUND OF THE INVENTION

1. Field of the Invention

The present invention relates to menu selection on an information display apparatus capable of displaying a picture integrally combining a plurality of dynamically changing images on a single display screen on a real-time basis.

2. Description of the Related Art

Recently developed information display apparatuses are often configured to display on a single screen a picture generated by integrating plural kinds of information fed from various sensing devices (information processing terminals) interconnected by a communications network. As an example, some information display apparatuses installed on vessels have a capability to integrate plural kinds of information derived from a plurality of onboard electronic devices, such a radar apparatus, a course plotter, an echo sounder, a facsimile receiver and an Automatic Identification System (AIS). Specific examples of such information display apparatuses are described in Japanese Patent Application Publication Nos. 1999-344554 and 2002-328159, for instance.

Information display apparatuses of this kind generate dynamically changing information using signals fed from a plurality of sensing devices and display the information thus generated (integrated) on a single screen in real time. These information display apparatuses can provide users with a wide variety of information which may include information concerning collision avoidance at sea, navigation-related information and/or fishing information, for instance.

FIG. 9 is a front view of a conventional information display apparatus used here for explaining an operating method thereof. Provided with a plurality of pushbuttons 300 on an operating panel as shown in FIG. 9, the conventional information display apparatus presents hierarchically structured menus corresponding to the individual pushbuttons 300, allowing a user to select a desired menu item on each menu displayed on-screen.

However, a menu system intended to enable the user to select a desired option from a large number of menu items by using a physically limited number of pushbuttons 300 should naturally have a deep-layered hierarchical menu structure so that the user can select menu options assigned to the pushbuttons 300 at each hierarchical level in the menu system. This structure of the prior art has a problem that the user is forced to go through many operating steps in search of a desired menu and menu option, resulting in a reduction in user operability. Additionally, since the user should operate the pushbuttons 300 which are located more or less apart from the menu options displayed on-screen in a process of menu selection, the conventional information display apparatus has a problem that it is difficult for the user to correctly accomplish menu selection onboard a vessel which is in continuous motion at sea.

Furthermore, in a case where the user is to operate the information display apparatus by using a remote controller 400 as illustrated in FIG. 10, there arises a problem that it is difficult to correctly accomplish menu selection by manipulating pushbuttons 300 on the remote controller 400. This is because the user can not easily recognize a relationship between the individual pushbuttons 300 on the remote controller 400 and contents of the menu items indicated on-screen as the remote controller 400 is located apart from a display unit of the information display apparatus.

Especially in an information display apparatus configured to display on a single screen a picture generated by integrating plural kinds of information sent from various information processing terminals, such as a radar apparatus, an echo sounder, and so forth, it is important that the user can easily maneuver through a hierarchical menu tree and select a desired function of each information processing terminal. Thus, there is a growing need for development of a new technique featuring a high degree of freedom in design which enables the user to easily select desired functions of individual information processing terminals which offer an increasingly large number of functions nowadays.

### SUMMARY OF THE INVENTION

In light of the aforementioned problems of the prior art, it is an object of the present invention to provide an information display apparatus which allows a user to select a desired function while displaying dynamically changing information obtained from various sensing devices (information processing terminals) on a single display screen on a real-time basis.

To overcome the aforementioned problems of the prior art, an information display apparatus of the invention comprises a plurality of sensing devices installed on a vessel, a signal processing portion for generating a plurality of images dynamically changing from time to time based on signals fed from the sensing devices, an information display portion for displaying at least one image selected from the plurality of dynamically changing images in a window defined on a display screen, a menu storage portion for storing a plurality of menu items relating to the dynamically changing images in a hierarchical menu structure, a rotary control used for menu selection, and a menu display portion for displaying the menu items relating to the currently displayed dynamically changing image in part of the display screen in such a way that the menu items displayed on-screen are scrolled in accordance with rotation of the rotary control.

In one feature of the invention, the sensing devices include an echo sounder for fish finding, a radar for detecting radar targets and a position sensor for supplying position information used for course plotting, for example, and the signal processing portion generates the images dynamically changing from time to time, such as an underwater echo image, a radar image and a course plotting image based on signals fed from these sensing devices.

During a process of menu selection, the menu display portion displays the menu items relating to the currently displayed dynamically changing image in part of the display screen in such a way that the menu items are scrolled in accordance with rotation of the rotary control. This arrangement permits a user to select a desired menu item by simply turning the rotary control while examining the image dynamically changing from time to time, thereby allowing the user to easily operate the information display apparatus even on a vessel in significant motion.

In another feature of the invention, the menu display portion displays on the display screen only part of a circle formed by the menu items which are virtually arranged in a circulating ring form and rotationally scrolls the menu items in accordance with rotation of the rotary control. In this case, the rotary control is located within a circle formed by the menu items which are virtually arranged in the circulating ring form and the menu items rotationally scroll around the rotary control in accordance with rotation thereof. This arrangement gives the user an impression that a ring of the menu icons displayed on-screen turns together with the rotary control, making it possible to further improve the user operability.

In another feature of the invention, the menu display portion may present information on the hierarchical level of the currently displayed menu items. For example, upon receiving an instruction to select one of the menu items categorized at a higher hierarchical level, the menu display portion may display the menu items categorized at a lower hierarchical level of the selected menu item of the higher hierarchical level while keeping part or all of the selected menu item displayed on-screen. Also, the menu display portion may display information to be used for judging whether each of the currently displayed menu items is associated with menu items at a lower hierarchical level. This arrangement enables the user to perform menu selection while recognizing the hierarchical level of the currently selected menu item, making it possible to further improve the user operability.

In another feature of the invention, the menu display portion displays part or all of each menu item at a higher hierarchical level in different ways depending on whether the pertinent menu item is associated with two or more than two menu items at the lower hierarchical level. For example, if the currently selected menu item is associated with two menu items representing ON and OFF states at the lower hierarchical level, the menu display portion displays the menu item together with information on the ON/OFF state of the currently selected menu item. With this arrangement, the user can switch between the ON and OFF states by entering an instruction to do so on the currently displayed menu of the higher hierarchical level without displaying the menu items of the lower hierarchical level.

In still another feature of the invention, when displaying the menu items at a higher hierarchical level, the menu display portion may display contents of a currently executed menu item at a lower hierarchical level. This arrangement enables the user to visually recognize the contents of the currently executed menu item without displaying the menu items at the lower hierarchical level.

In yet another feature of the invention, the information display apparatus may be configured such that the menu storage portion stores multiple sets of menu groups, and the menu display portion selects one set of menu groups whereby menu selection is enabled by choosing menu items contained in the selected set of menu groups by operating the rotary control. Specifically, the menu storage portion stores in advance multiple sets of menu groups containing menus for users with different skill levels, such as beginner-level, intermediate-level and high-level users, and the user is allowed to select one set of menu groups appropriate for the level of own skill. This arrangement serves to further improve the user operability.

In a further feature of the invention, the menu display portion may display the menu items in the form of menu icons having a specific transmission factor which are superimposed on the currently displayed dynamically changing image.

The information display apparatus of the present invention permits the user to select functions relating to the currently displayed image by intuitive operation using the rotary control while observing the image dynamically changing on a real-time basis. In this information display apparatus, a desired function can be selected from a plurality of menu items by operating the single rotary control. Since menu selection is accomplished by software-based operation in this invention, the number of menu items selectable at each hierarchical level is not specifically limited but can be freely increased and decreased so that the degree of freedom in design of the apparatus is greatly improved.

Furthermore, since the information display apparatus presents the selectable menu items together with information on the hierarchical level of the menu items on the menu icons corresponding thereto, the user can select the desired menu item by intuitive operation referring to the information presented on the menu icons. This serves to permit even easier menu selection by the user.

These and other objects, features and advantages of the invention will become more apparent upon a reading of the following detailed description in conjunction with the accompanying drawings.

### BRIEF DESCRIPTION OF THE DRAWINGS

FIG. 1 is a block diagram showing the configuration of an information display apparatus according to a first embodiment of the invention;

FIG. 2 is a diagram showing an example of an on-screen display format of the information display apparatus of the first embodiment;

FIG. 3 is a diagram showing an example of a hierarchical menu tree containing menus stored in a menu storage block of the information display apparatus of the first embodiment;

FIGS. 4A-4F are diagrams for explaining the working of the information display apparatus of the first embodiment;

FIG. 5 is a flowchart showing a menu selection sequence executed after a window for which menu selection is to be enabled has been selected in the information display apparatus of the first embodiment;

FIG. 6 is a flowchart showing how menu icons are displayed on the information display apparatus of the first embodiment;

FIG. 7A-7C is a diagram showing an example of menu groups stored in a menu storage block of an information display apparatus according to a second embodiment of the invention;

FIG. 8 is a diagram showing the configuration of an information display apparatus according to a third embodiment of the invention;

FIG. 9 is a diagram showing the configuration of a conventional information display apparatus; and

FIG. 10 is a diagram showing the configuration of a conventional information display apparatus provided with a remote controller.

### DETAILED DESCRIPTION OF THE PREFERRED EMBODIMENTS OF THE INVENTION

Specific embodiments of the invention are now described in detail with reference to the accompanying drawings.

### First Embodiment

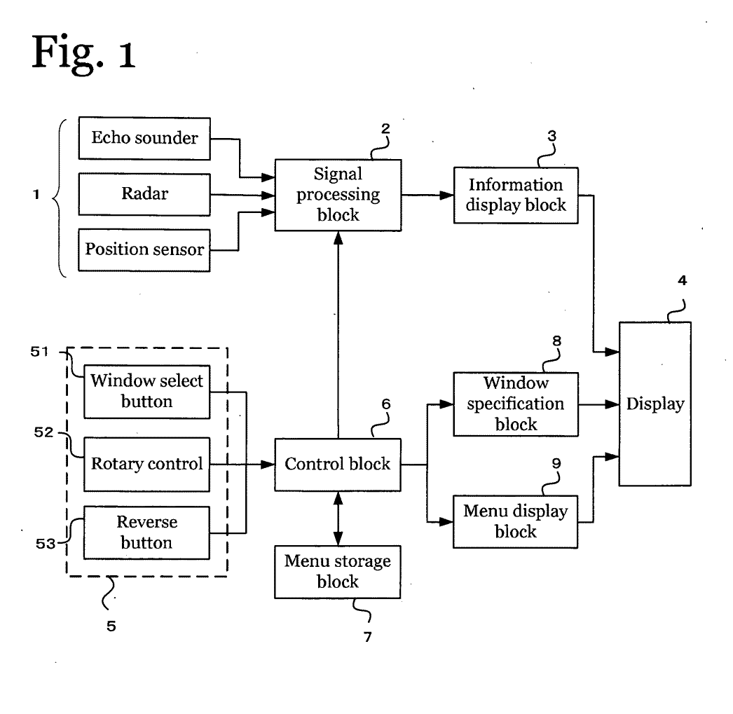

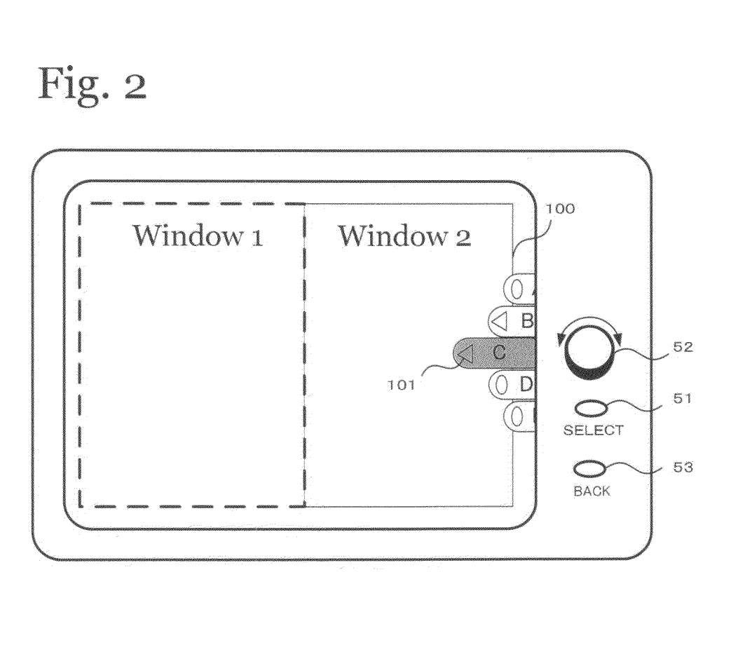

FIG. 1 is a block diagram showing the configuration of an information display apparatus according to a first embodiment of the invention, and FIG. 2 is a diagram showing an example of an on-screen display format of the information display apparatus of the first embodiment.

Referring to FIG. 1, the information display apparatus of the first embodiment comprises a group of various sensors 1 (hereinafter referred to as the sensor group 1), a signal processing block 2, an information display block 3, a display 4, an operating block 5, a control block 6, a menu storage block 7, a window specification block 8 and a menu display block 9. The operating block 5 includes a window select button 51, a rotary control 52 and a reverse button 53.

The aforementioned sensor group 1 includes such sensing devices as an echo sounder for detecting fish schools, a radar for detecting radar targets and a position sensor for determining own ship position and supplying position information used for course plotting as shown in FIG. 2, for example. The echo sounder transmits an acoustic pulse signal underwater and receives returning echoes through a transducer unit, and supplies an echo signal formatted in a specified data format to the signal processing block 2. The radar transmits a microwave pulse signal and receives returning echoes through a radar antenna and supplies an echo signal formatted in a specified data format to the signal processing block 2. The position sensor is such a positioning apparatus as a Global Positioning System (GPS) receiver which detects the own ship position and supplies a signal containing the position information to the signal processing block 2 to enable the information display apparatus to plot the own ship position on a map displayed on-screen.

The signal processing block 2, which is an information processor including a central processing unit (CPU), generates one or more kinds of information of which values dynamically change from time to time using the aforementioned sensor signals fed from the individual sensing devices of the sensor group 1. The information display block 3 produces a picture for on-screen presentation of the dynamically changing information generated by the signal processing block 2 in a predetermined display mode or in a user-selected display mode. The picture produced by the information display block 3 is presented on the display 4 in the applicable display mode which contains at least such pieces of information as the number of segmental areas into which an entire display area of the display 4 is divided and types of dynamically changing images (e.g., radar image, echo-sounding image and/or course plotting) to be presented in the individual segmental areas. With these pieces of information defined by the display mode, the information display block 3 synthesizes the relevant images dynamically changing from time to time obtained from the sensor signals fed from the corresponding sensing devices to produce a picture to be displayed on a single display screen of the display 4.

The window select button 51 permits a user to select one of windows for which menu selection should now be enabled. In a case where the display screen is divided into two segmental areas to present pictures showing two different kinds of information (such as a radar picture in one segmental area and an echo sounding picture in the other segmental area), for example, the user is allowed to switch between the two segmental areas by pressing the window select button 51. In the illustrated example of FIG. 2, the user can alternately switch between “Window 1” and “Window 2” which correspond to the two segmental areas, for which menu selection is individually possible, by successively pressing the window select button 51 (“SELECT” button 51 shown in FIG. 2). The segmental area surrounded by thick dashed lines in FIG. 2, or Window 1, is currently selected for menu selection. If the user manipulates the rotary control 52 in this condition where Window 1 is selected as shown in FIG. 2, the display 4 shows menu icons which enable selection of menu items related to the information currently displayed in Window 1.

The rotary control 52 is means for selecting a desired menu item. Specifically, the rotary control 52 is a rotational angle sensing device like a rotary encoder, for example. When turned by the user, the rotary control 52 senses user intervention and transmits a command to the control block 6, thereby causing the control block 6 to show relevant menu icons on-screen. At the same time, the rotary control 52 senses the amount of manipulation by the user, or the angle of rotation of the rotary control 52, and transmits a command to the control block 6 indicating the amount of scrolling of the menu icons to be displayed on-screen. Subsequently, as the user depresses the rotary control 52, the rotary control 52 senses a depressing action of the user and transmits a command to the control block 6, thereby causing the control block 6 to execute a specified operation related to the specified menu icon. The aforementioned arrangement of the present embodiment enables the information display apparatus to execute a complete sequence of user instructions concerning menu selection entered through the rotary control 52, thus allowing the user to easily perform menu selection even on a vessel in significant motion. Consequently, the present embodiment of the invention serves to overcome such inconvenience that the user would experience when selecting menu items on a conventional information display apparatus by using hardware keys thereof which are located more or less apart from the menu items displayed on-screen.

The reverse button 53 (“BACK” button 53 shown in FIG. 2) is a key which allows the user to return the information display apparatus one step backward along an operating sequence related to menu selection. Specifically, if the user presses the BACK button 53 under conditions where some menu items (menu icons) are displayed on-screen as a result of user intervention with the rotary control 52 in the menu selection sequence, for instance, the control block 6 brings the information display apparatus one step backward to a state in which no menu items are displayed on-screen. Also, if the user presses the BACK button 53 under conditions where menu items of a lower hierarchical level are displayed after selecting one of menu items of a higher hierarchical level, for instance, the control block 6 brings the information display apparatus one step backward to a state in which the menu items of the higher hierarchical level are displayed.

Upon receiving an operation signal output from the operating block 5 which serves as a user interface, the control block 6 causes individual processing devices of the apparatus to perform specific operations according to user inputs.

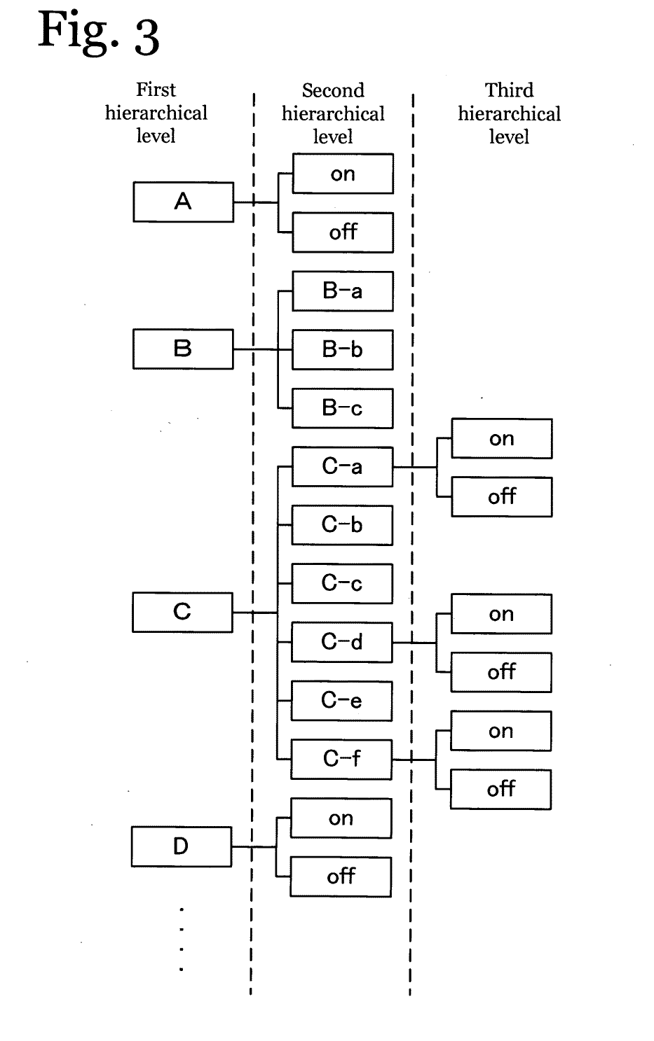

The menu storage block 7 stores a plurality of menu groups for different types of dynamically changing images-produced by using the sensor signals output from the individual sensing devices of the sensor group 1. These menu groups include a menu group containing multiple menu items for the radar, a menu group containing multiple menu items for the echo sounder, and a menu group containing multiple menu items for course plotting, for example. In this embodiment, the menu items constituting the individual menu groups are arranged in a hierarchical menu structure (hierarchical menu tree) as shown in an example of FIG. 3.

The window specification block 8 specifies a type of dynamically changing image for which menu selection is now to be enabled. In the information display apparatus of the present embodiment, one of the windows for which menu selection is currently enabled is circumscribed by the thick dashed lines as shown in FIG. 2. The window specification block 8 switches the window for which menu selection is to be enabled according to a control signal fed from the control block 6.

The menu display block 9 displays menu icons corresponding to specific menu items stored in the menu storage block 7 by superimposing the menu icons on the dynamically changing images presented on the display 4 and moves the menu icons displayed on-screen in accordance with user instructions entered through the operating block 5. A complete set of menu icons is virtually arranged in a circulating ring form. The menu display block 9 circulates, or scrolls, the complete menu icon set while controlling on-screen positions of the menu icons so that part of the menu icon set can be seen on the display 4. New menu icons successively emerge from an edge of the display screen in accordance with rotation of the rotary control 52 which is located close to the display screen as shown in FIG. 2, so that the scrolling menu icons appear as if turning around the rotary control 52. This arrangement of the embodiment gives the user an impression that a ring of the menu icons displayed on-screen turns together with the rotary control 52.

In a case where the entire area of the display screen is divided into multiple segmental areas to display plural kinds of dynamically changing images, the menu icons may be displayed to straddle a border line between two adjacent segmental areas. With this arrangement, the menu icons can be displayed to overlie the equally divided adjacent segmental areas by the same amount so that the currently displayed dynamically changing images will not excessively be hidden by the menu icons as much as possible, yet allowing the user to accomplish menu selection. Preferably, the menu icons presented by the menu display block 9 have a specific transmission factor to ensure that the menu icons will not greatly reduce visibility of the dynamically changing images displayed on the display 4.

To permit the user to easily recognize the currently selectable menu item, the menu display block 9 presents the menu icon corresponding to this menu item in gray and to extend further beyond other menu icons as shown in FIG. 2. Since the menu icon of the currently selectable menu item is presented to extend further beyond the other menu icons in this way, even an user having a color recognition problem can easily recognize the menu icon corresponding to the currently selectable menu item.

As depicted in the example of FIG. 2, the menu display block 9 shows the menu items represented by the menu icons which are associated with oval marks 100 or triangular marks 101. Each of the oval marks 100 indicates that the relevant menu item has a lower hierarchical level which offers two menu options, such as ON and OFF, as shown in FIG. 3. Additionally, the oval mark 100 on each menu icon is lit or extinguished to indicate whether a function (command) corresponding to the pertinent menu item is executed at present. With this arrangement, the user can switch between ON and OFF by entering an instruction to do so on a currently displayed menu of a higher hierarchical level without displaying menu items of the lower hierarchical level. It is to be noted that the menu options offered on a lower-level menu in the hierarchical menu tree are not limited to ON and OFF. For example, even when a lower-level menu offers two menu options other than ON and OFF, it is possible to switch between the two menu options without displaying a menu of the lower hierarchical level if content of each menu option is alternately displayed according to the user instruction to select one of the menu options.

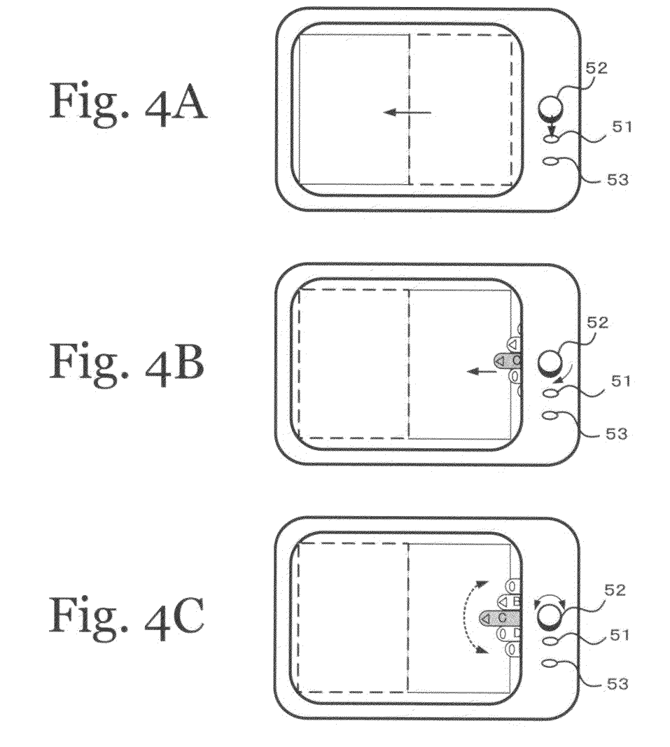

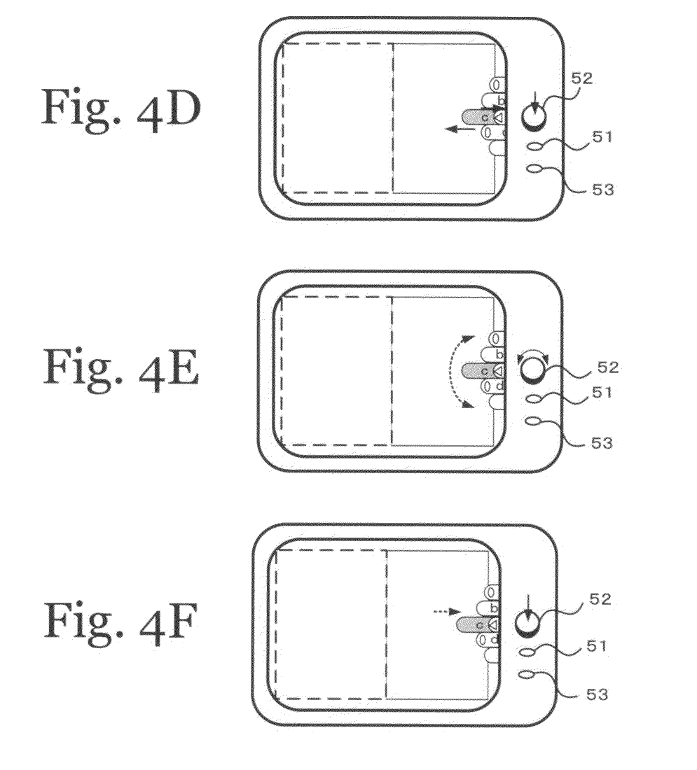

On the other hand, each of the triangular marks 101 indicates that the relevant menu item has a lower hierarchical level which offers more than two menu options. When the user selects a menu item represented by a menu icon associated with the triangular mark 101, menu icons representing menu items of the currently selected hierarchical level disappear and menu icons representing menu items of a relevant lower hierarchical level are displayed. At this time, part of the menu icon representing the user-selected menu item may be left displayed on the screen as shown in FIG. 4E to enable the user to visually recognize that the newly displayed menu icons represent the menu items under the menu item at the higher hierarchical level.

A menu icon associated with neither the oval mark 100 nor the triangular mark 101 represents a lowest-level menu item which offers no more lower-level menu items. When the user selects the lowest-level menu item, a function (command) corresponding to the menu item is executed. As the menu icons are associated with information concerning levels of the menu items in the hierarchical menu tree as discussed above, it is possible to offer improved user operability.

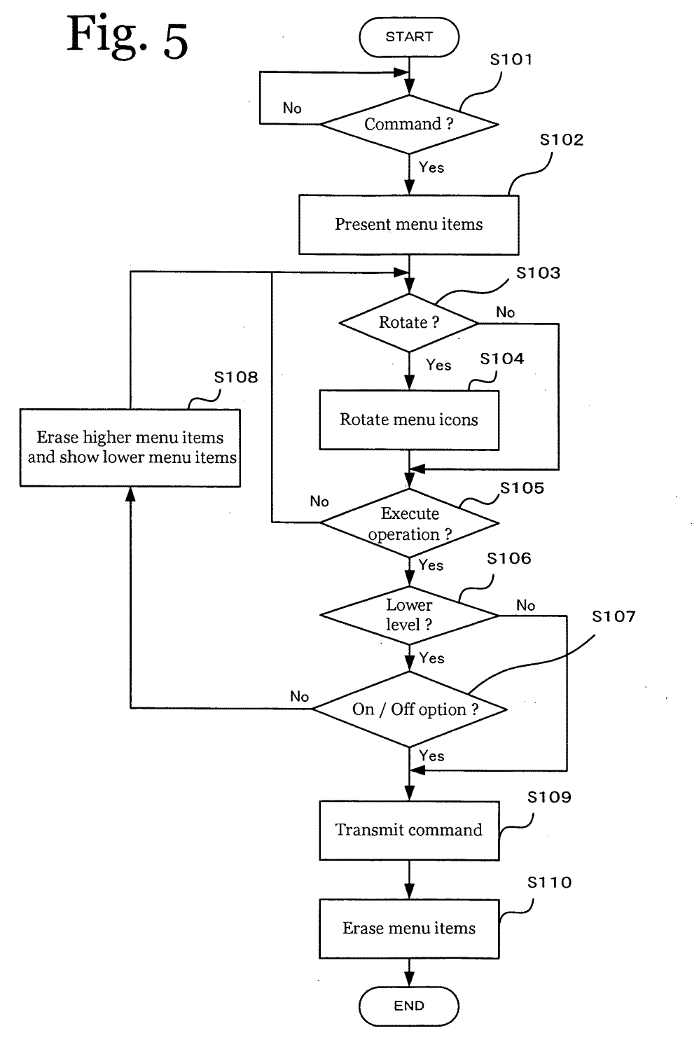

Referring now to FIGS. 4A-4F and 5, the working and operation of the information display apparatus of first embodiment of the present invention are described.

FIGS. 4A-4F are diagrams for explaining the working of the information display apparatus of the first embodiment, particularly showing an example of how on-screen presentation varies as a result of operation by the user. In the example discussed hereunder, the on-screen presentation varies from FIG. 4A to FIG. 4F in this order. FIG. 5 is a flowchart-showing a menu selection sequence executed after a window for which menu selection is to be enabled has been selected.

First, the user presses the window select button 51 (“SELECT” button shown in FIG. 4A) to select one of the windows for which menu selection should now be enabled. Each time the user presses the “SELECT” button 51, the window, or the segmental area of the display screen, for menu selection circumscribed by the thick dashed lines is switched from one side to the other.

If the user turns the rotary control 52 after selecting one of the windows for menu selection, the rotary control 52 transmits a menu display command to the control block 6 (step S101). Upon receiving the menu display command, the control block 6 reads out menus for a dynamically changing image displayed in the window currently selected for menu selection from the menu storage block 7 and causes the menu display block 9 to present menu items at a highest hierarchical level of the menus read out from the menu storage block 7 (step S102).

While the user turns the rotary control 52 to enter the menu display command in step S101 described above, the embodiment may be modified such that the control block 6 causes the menu display block 9 to present the menu items when triggered by a depression of the rotary control 52 or manipulation of another button. Also, while the menu icons emerge from one side of the display screen as if sliding horizontally inward as shown in FIG. 4B in the present embodiment, this form of menu icon presentation may be varied such that the menu icons emerge in a rotational sliding motion or instantly emerge at the moment that the menu display block 9 accepts the menu display command, for example.

When the control block 6 detects rotation of the rotary control 52 (step S103) after presenting the menu icons, the control block 6 causes the menu display block 9 to rotationally scroll the menu icons displayed on-screen in accordance with rotation of the rotary control 52 (step S104). The on-screen menu icons move in a rotational motion around the rotary control 52 in accordance with rotation of the rotary control 52 as shown in FIG. 4C. With this arrangement, the menu icons rotationally scroll in accordance with rotation of the rotary control 52, thereby giving the user has an intuitive feeling of operation.

When depressed by the user, the rotary control 52 transmits a command to the control block 6 to execute particular operation corresponding to a selected menu item (menu icon). Upon receiving this command (step S105), the control block 6 judges whether the selected menu item has any lower-level menu items in the hierarchical menu tree (step S106).

If there is no lower hierarchical level in step S106, the control block 6 causes the signal processing block 2 to execute the command corresponding to the selected menu item (step S109). If there is a lower hierarchical level in step S106, on the other hand, the control block 6 judges whether the lower-level menu items are ON/OFF options (step S107).

If the menu items at the lower hierarchical level are ON/OFF options, the control block 6 transmits a command to the signal processing block 2 to select ON or OFF according to a user instruction (step S109). At the same time, the control block 6 transmits a command to the signal processing block 2 to switch the oval mark 100 on the selected menu icon between lit and extinguished states according to conditions of execution of the selected menu item.

If the menu items at the lower hierarchical level are not ON/OFF options in step S107, it is necessary to carry out further operation for menu selection, so that the control block 6 causes the menu display block 9 to erase the menu items at the currently selected higher hierarchical level and show menu items at the lower hierarchical level (step S108). FIG. 4D shows an on-screen menu presentation at this stage. To permit the user to recognize that the currently displayed menu icons represent the menu items at the lower hierarchical level at this point, part or all of the menu icon previously selected at the higher hierarchical level is kept displayed on-screen as shown in FIG. 4E. After the menu items at the lower hierarchical level have been displayed, menu selection operation is performed by the same procedure as discussed in steps S103 to S107 above.

By transmitting a command for executing operation corresponding to the menu item selected in step S109, the control block 6 causes the signal processing block 2 to perform the specified operation and displays results of the operation on the display screen. At this point, the menu icons are kept presented on-screen and the results of the menu selection operation are reflected in the dynamically changing image displayed on-screen. Therefore, the user can determine whether to carry out further menu selection operation while examining how the results of the previous menu selection operation are reflected in the image displayed on the screen.

If no user instruction to execute a further command is entered within a specified period after the command for performing the operation corresponding to the selected menu item has be executed, the control block 6 causes the menu display block 9 to erase the currently displayed menu items (step S110) and terminates the menu selection operation (FIG. 4F). Although not shown in FIG. 5, the control block 6 also erases the currently displayed menu items when detecting that no further menu selection operation is performed within a predetermined period of time.

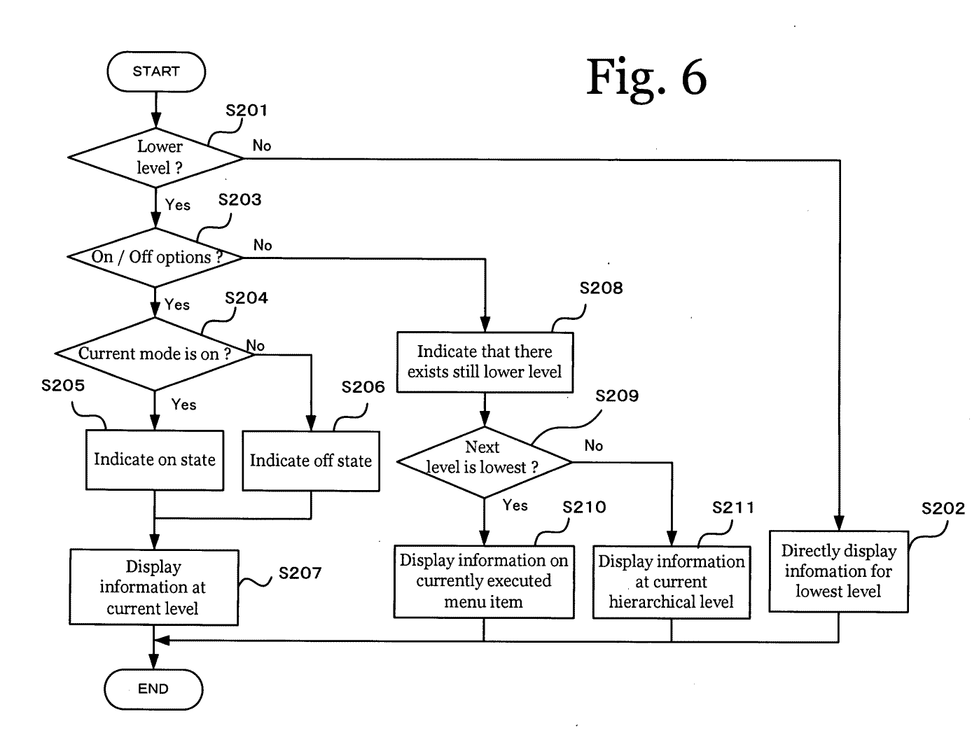

FIG. 6 is a flowchart showing how menu icons are displayed on the information display apparatus of the first embodiment.

In a process of displaying appropriate menu icons, the control block 6 first judges whether the selected menu item has any menu items at a lower hierarchical level (step S201). If there are no lower-level menu items, the control block 6 causes the menu display block 9 to present only such on-screen information that represents the currently selectable menu items (step S202). Referring to the example of the hierarchical menu tree shown in FIG. 3, presentation of menu items selectable at a second hierarchical level in menu “B” corresponds to menu display operation in step S202, in which the menu display block 9 presents “B-a”, “B-b” and “B-c” as the on-screen information representing the currently selectable menu items. In this case, the menu icons representing the menu items are not associated with the oval marks 100 or the triangular marks 101 shown in FIG. 2. In this embodiment, the menu items “B-a”, “B-b” and “B-c” at the lower hierarchical level are presented in such a manner that the user can recognize which one of the menu items is currently executed by presenting the pertinent menu item in color, for example.

If the selected menu item is judged to have menu items at the lower hierarchical level in step S201, the control block 6 judges whether the lower-level menu items are ON/OFF options (step S203). If the menu items at the lower hierarchical level are ON/OFF options in step S203, the control block 6 further judges whether the currently selected option is ON or OFF (step S204). If the menu items at the lower hierarchical level are not ON/OFF options in step S203, the control block 6 proceeds to step S208.

If the currently selected option is judged to be ON in step S204, the control block 6 causes the menu display block 9 to indicate that a function corresponding to the pertinent menu item is in an ON state (step S205). If the currently selected option is judged to be OFF in step S204, the control block 6 causes the menu display block 9 to indicate that the function corresponding to the pertinent menu item is in an OFF state (step S206). One form of indicating the ON/OFF states is to use the oval marks 100 shown in FIG. 2. For example, when the function corresponding to the pertinent menu item is in the ON state in step S204, the control block 6 causes the menu display block 9 to light an inside area of the oval mark 100 on the menu icon representing the menu item. When the function corresponding to the pertinent menu item is in the OFF state in step S204, on the contrary, the control block 6 causes the menu display block 9 to extinguish the inside area of the oval mark 100 on the menu icon. Even when the currently selected menu item is in other than the ON/OFF states, it is possible to indicate which one of the menu items at the lower hierarchical level is currently selected if information on the lower-level menu items is expressed by a string of characters (text), for example. The control block 6 also causes the menu display block 9 to indicate the on-screen information representing the currently selectable menu items (step S207). In the example of FIG. 3, presentation at a first hierarchical level in menu “A” corresponds to menu display operation in steps S204 to S207 above, in which the menu display block 9 presents “A” representing the currently selected menu item and lights or extinguishes the oval mark 100 as the on-screen information on the pertinent menu item.

If the menu items at the lower hierarchical level are judged to be other than the ON/OFF options in step S203, the control block 6 causes the menu display block 9 to indicate that there exists a still lower hierarchical level (step S208). One form of indicating the presence of the still lower hierarchical level is to use the triangular marks 101 shown in FIG. 2. The control block 6 judges whether the next hierarchical level is a lowest hierarchical level (step S209). If the next hierarchical level is the lowest hierarchical level in step S209, the control block 6 causes the menu display block 9 to indicate on-screen information on the currently executed menu item at the lowest hierarchical level together with the triangular mark 101 (step S210). In the example of FIG. 3, presentation at the first hierarchical level in menu “B” corresponds to menu display operation in step S210, in which the menu display block 9 presents the currently executed one of menu items “B-a”, “B-b” and “B-c” together with the triangular mark 101 indicating the presence of the still lower hierarchical level as the on-screen information.

According to this menu display operation, the information display apparatus enables the user to obtain information indicating which one of the menu items “B-a”, “B-b” and “B-c” at the lower hierarchical level is currently executed, making it possible to further improve the user operability.

If the next hierarchical level is not the lowest hierarchical level in step S209, on the other hand, the control block 6 causes the menu display block 9 to indicate on-screen information representing the currently selectable menu items (step S211). In the example of FIG. 3, presentation at the first hierarchical level in menu “C” corresponds to menu display operation in step S211, in which the menu display block 9 presents “C” representing the currently selected menu item together with the triangular mark 101 indicating the presence of the still lower hierarchical level. In this embodiment, the control block 6 may cause the menu display block 9 to present the on-screen information representing the currently selectable menu items on the corresponding menu icons regardless of whether the next hierarchical level is the lowest hierarchical level.

As will be understood from the foregoing discussion, the information display apparatus of the first embodiment permits intuitive operation by use of the rotary control 52, making it possible to easily select desired menu items while continuously observing the images dynamically changing on a real-time basis. Additionally, since the number of selectable menu items can be freely altered by software, the above-described configuration greatly improves the degree of freedom in design of the apparatus.

Furthermore, since the information display apparatus presents the selectable menu items together with information on the hierarchical level of the menu items on the menu icons corresponding thereto, the user can select the desired menu item by intuitive operation referring to the information presented on the menu icons. This serves to permit even easier menu selection by the user.

While the window select button 51 and the window specification block 8 of the information display apparatus of the first embodiment enable the user to select one of the windows for menu selection, the information display apparatus may be configured to permit menu selection without the provision of the window select button 51 and the window specification block 8. This will be accomplished by providing a menu for menu selection at the highest hierarchical level of a menu structure and allowing the user to select one of the windows for menu selection by operating the rotary control 52, for example.

### Second Embodiment

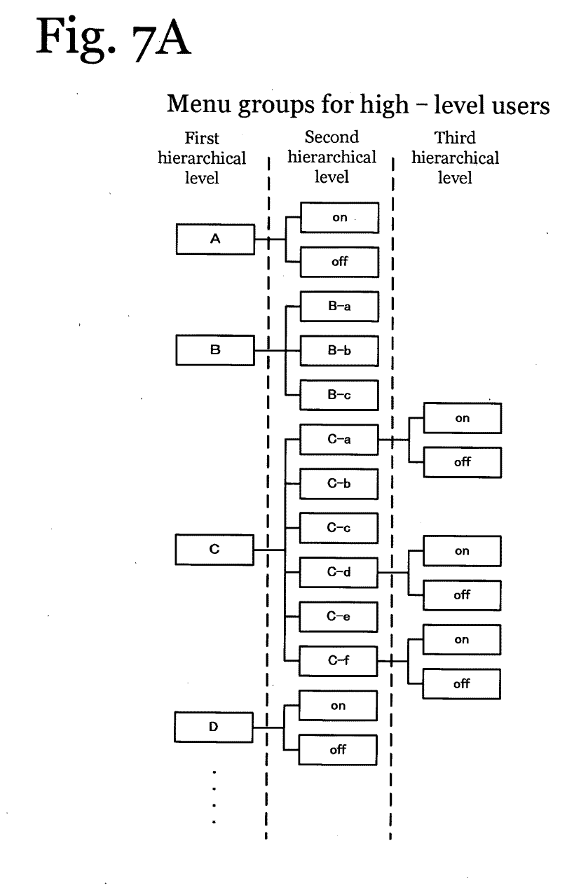

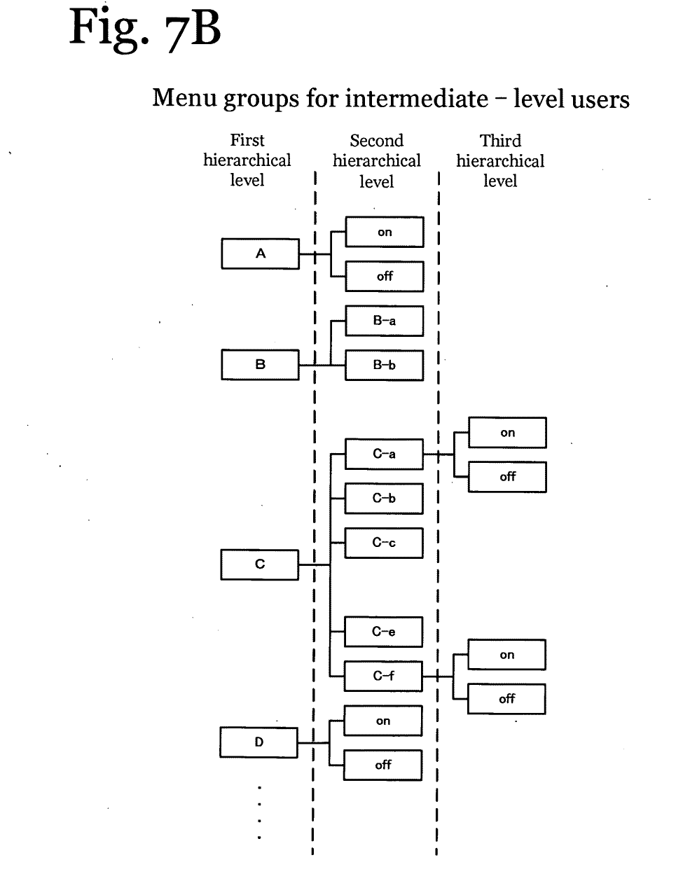

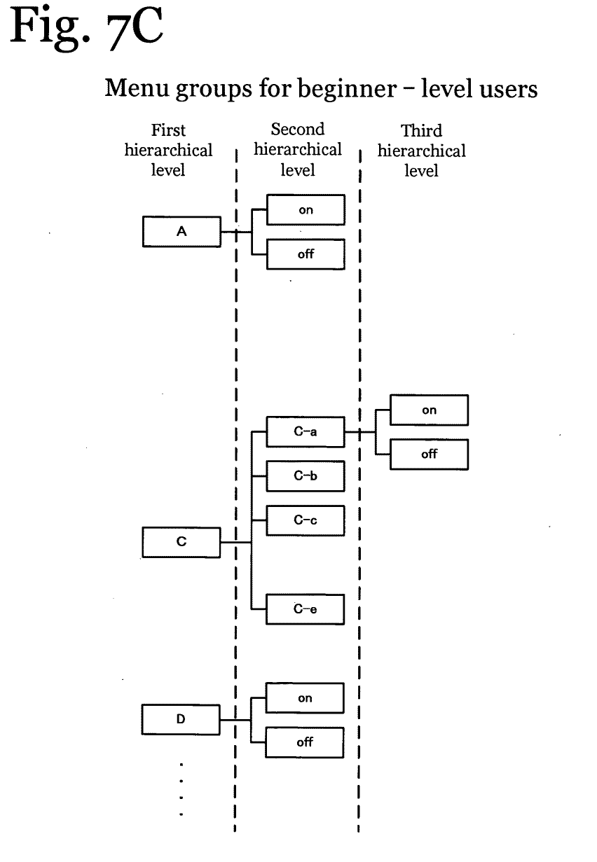

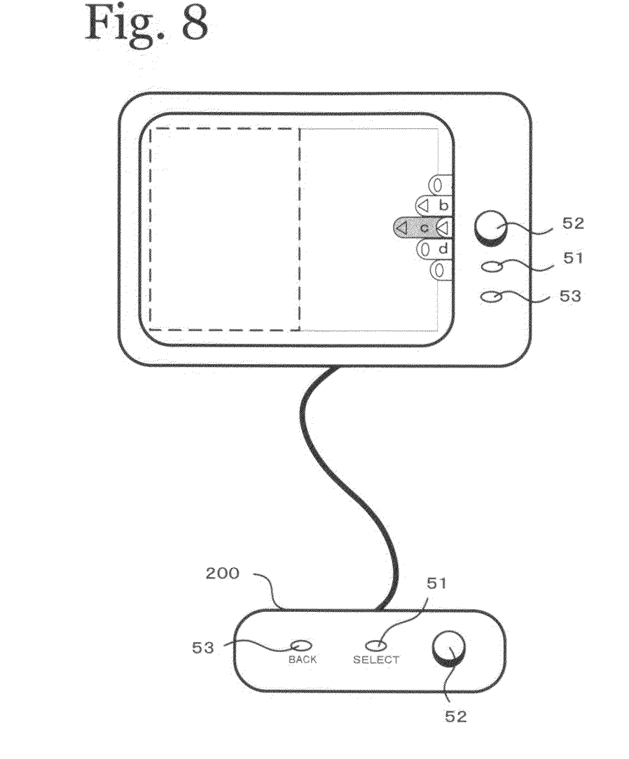

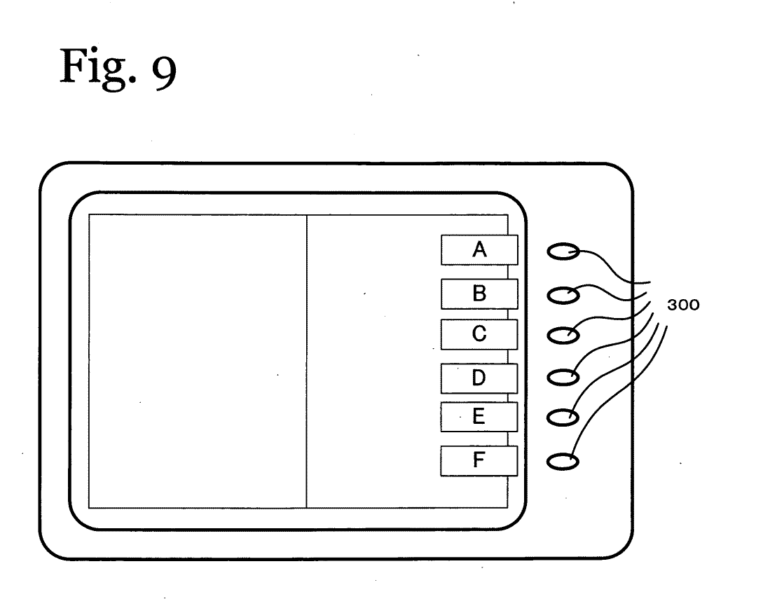

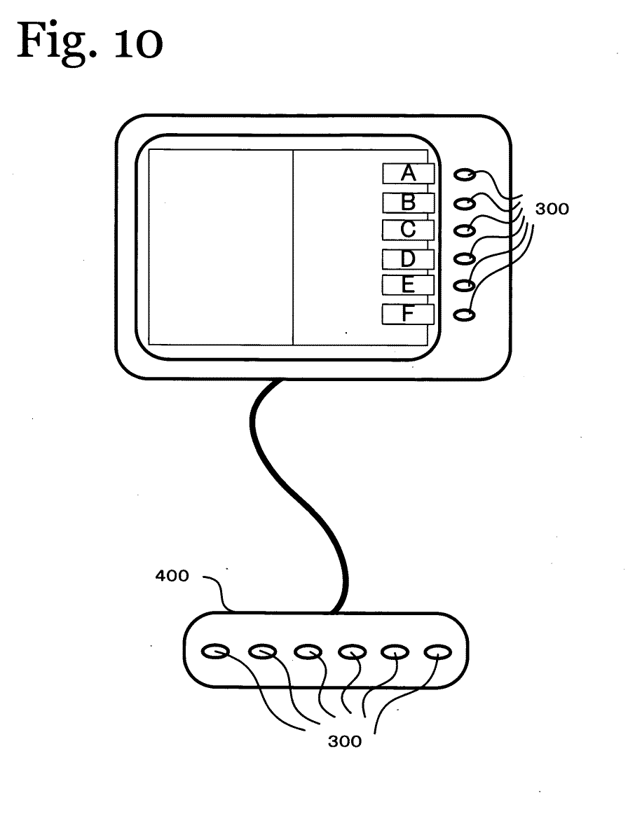

An information display apparatus according to a second embodiment of the invention is now described with reference to FIG. 7A-7C which is a diagram showing an example of menu groups provided by the information display apparatus.

The information display apparatus of the second embodiment differs from that of the first embodiment in that the menu storage block 7 stores multiple sets of menu groups containing menus for users with different skill levels.

In the example shown in FIG. 7A-7C, the menu storage block 7 stores sets of menu groups for beginner-level, intermediate-level and high-level users. Each set of menu groups includes a menu group containing multiple menu items for the radar, a menu group containing multiple menu items for the echo sounder, and a menu group containing multiple menu items for course plotting, for example, as previously mentioned with reference to FIG. 3.

The information display apparatus of this embodiment permits the user to select one set of menu groups in an initialization stage, for example. Upon accepting a menu display command entered by the user, the control block 6 of the information display apparatus reads out the user-specified set of menu groups, so that the information display apparatus can present menus suited to the level of user skill.

Needless to say, the information display apparatus may allow the user to freely customize the multiple sets of menu groups prepared in advance. Alternatively, the information display apparatus may be configured to allow the user to selectively store often used menu items only in the menu storage block 7. Still alternatively, the information display apparatus may be configured to switch from the previously selected set of menu groups to another set of menu groups when triggered by a prolonged depression of the rotary control 52, for example.

### Third Embodiment

An information display apparatus according to a third embodiment of the invention is now described with reference to FIG. 8 which is a diagram showing the configuration of the information display apparatus.

The information display apparatus of the third embodiment differs from that of the first embodiment in that the information display apparatus is controlled by use of a remote controller 200.

Like the operating block 5 of the information display apparatus, the remote controller 200 is provided with a window select button 51, a rotary control 52 and a reverse button 53 to perform the same functions and operations as the operating block 5 of the information display apparatus described in the foregoing first embodiment.

While the invention has thus far been described with reference to the preferred embodiments thereof, it is to be understood that the invention is not limited to these illustrative embodiments but may be modified without departing from the scope and spirit of the invention defined by the appended claims.

What is claimed is:

1. An information display apparatus connecting a plurality of sensing devices comprising:
a signal processing portion for generating a plurality of images dynamically changing from time to time based on signals fed from said sensing devices;
an information display portion for displaying at least one image selected from said plurality of dynamically changing images in a window defined on a display screen;
a menu storage portion for storing a plurality of menu items relating to the dynamically changing images in a hierarchical menu structure;
a rotary control used for menu selection; and
a menu display portion for displaying the menu items relating to the currently displayed dynamically changing image in part of the display screen in such a way that the menu items displayed on-screen are scrolled in accordance with rotation of said rotary control.

2. The information display apparatus according to claim 1, wherein said sensing devices include at least one of an echo sounder for fish finding, a radar for detecting radar targets and a position sensor for supplying position information used for course plotting.

3. The information display apparatus according to claim 1, wherein said menu display portion displays part of a circle formed by the menu items which are virtually arranged in a circulating ring form and rotationally scrolls the menu items in accordance with rotation of said rotary control.

4. The information display apparatus according to claim 3, wherein said rotary control is located within a circle formed by the menu items which are virtually arranged in the circulating ring form and the menu items rotationally scroll around said rotary control in accordance with rotation thereof.

5. The information display apparatus according to claim 1, wherein, upon receiving an instruction to select one of the menu items categorized at a higher hierarchical level, said menu display portion displays the menu items categorized at a lower hierarchical level of the selected menu item of the higher hierarchical level while keeping at least part of the selected menu item displayed on-screen.

6. The information display apparatus according to claim 1, wherein said menu display portion displays information to be used for judging whether each of the currently displayed menu items is associated with menu items at a lower hierarchical level.

7. The information display apparatus according to claim 6, wherein said menu display portion displays at least part of each menu item at a higher hierarchical level in different ways depending on whether the pertinent menu item is associated with two or more than two menu items at the lower hierarchical level.

8. The information display apparatus according to claim 6, wherein, if the currently selected menu item is associated with two menu items representing ON and OFF states at the lower hierarchical level, said menu display portion displays the menu item together with information on the ON/OFF state of the currently selected menu item.

9. The information display apparatus according to claim 1, wherein, when displaying the menu items at a higher hierarchical level, said menu display portion displays contents of a currently executed menu item at a lower hierarchical level.

10. The information display apparatus according to claim 1, wherein said menu storage portion stores multiple sets of menu groups, and said menu display portion selects one set of menu groups whereby menu selection is enabled by choosing menu items contained in the selected set of menu groups by operating said rotary control.

11. The information display apparatus according to claim 1, wherein said menu display portion displays the menu items in the form of menu icons having a specific transmission factor which are superimposed on the currently displayed dynamically changing image.
